(19) United States
(12) Patent Application Publication
(10) Pub. No.: US 2022/0400156 A1
(43) Pub. Date: Dec. 15, 2022

(54) PATTERNS TO LEVERAGE GRPC IN SMALL FOOTPRINT EMBEDDED SYSTEM

(71) Applicant: Infinera Corp., San Jose, CA (US)

(72) Inventors: Aaron Menon, Ladera Ranch, CA (US); Prashaanth Ragupathy, San Francisco, CA (US); Madhura Joshi, Fremont, CA (US); Liang Hong, San Jose, CA (US)

(21) Appl. No.: 17/840,134

(22) Filed: Jun. 14, 2022

Related U.S. Application Data
(60) Provisional application No. 63/210,529, filed on Jun. 15, 2021.

(51) Int. Cl. H04L 67/133; H04B 10/27

(52) U.S. Cl. CPC H04L 67/133; H04B 10/27

(57) ABSTRACT

Disclosed herein are network elements for use in a transport network. The network elements may comprise an embedded device comprising a processor, a communication device, and a non-transitory computer readable medium storing a common client interface comprising processor-executable code that when executed causes the processor to, responsive to receiving a request from a particular one of a plurality of client applications: allocate one or more system resource for the particular one of the plurality of client applications, the one or more system resource based at least in part on a request type of the request; establish, with the communication device, a connection with a remote network element in the transport network; and transmit the request to the remote network element; and responsive to receiving a response from the remote network element, transmit the response to the particular one of the plurality of client applications.

### CROSS-REFERENCE TO RELATED APPLICATION

This application claims priority to U.S. Provisional Patent Application No. 63/210,529, filed Jun. 15, 2021, entitled “Patterns to Leverage GRPC in Small Footprint Embedded System”, the entire contents of which are incorporated herein by reference.

### BACKGROUND

System resources, as used herein, may include any combination of memory, non-volatile storage (e.g., a hard disk drive, a solid-state drive, etc.), computer processing time, and network traffic.

Embedded systems are typically designed to consume limited system resources. For instance, software images must be small enough to store on the non-volatile storage of the embedded system. Memory use must be minimized and must be deterministic so as to not exceed the memory of the embedded system. Software must be maximally performant so as to not overly tax the limited CPU of the embedded system. Further, it is likely that innovation will trend toward even more limited system resources as part of a continuous process of reducing cost.

Legacy examples of systems utilizing a client-server architecture do not adequately accommodate the limited system resources of embedded systems. For instance, network traffic in such systems is typically proportional to the number of clients; this will sub-optimally consume the limited network bandwidth of the embedded system. Further, code size in such systems is typically proportional to the number of Managed Objects; this will sub-optimally consume the limited storage and memory of the embedded system. Finally, such systems are typically provided with tight coupling between services; this reduces the flexibility and reliability of the code because each of the services are dependent on one another.

### SUMMARY

The problems of conventional methodologies for implementing a client-server architecture for embedded systems are addressed by transport networks utilizing a common client interface for communicating with a server that provides: a common software layer accessible by each client application running on a client device; an optimized codebase that reduces the amount of space that must be reserved for the Application Programming Interface (“API”); just-in-time (or “on-demand”) resource acquisition that eliminates system resources reserved for each of the client applications until a particular one of the client applications requires such resources; subscription aggregation that reduces system resources required for open subscriptions; distributed data aggregation that aggregates data from multiple data collectors at a single collection point; and independent microservices that ensure that the failure of one microservice does not impact the operation of other dependent microservices.

In one aspect, in accordance with some implementations, the disclosure describes a network element, the network element comprising: an embedded device comprising a processor; a communication device in communication with the embedded device and operable to communicate via a communication network; and a non-transitory computer readable medium storing a common client interface comprising processor-executable code that when executed causes the processor to: responsive to receiving a request from a particular one of a plurality of client applications: allocate one or more system resource for the particular one of the plurality of client applications, the one or more system resource based at least in part on a request type of the request; establish, with the communication device, a connection with a remote network element in the transport network; and transmit the request to the remote network element via the connection; and responsive to receiving a response from the remote network element via the connection, transmit the response to the particular one of the plurality of client applications.

In another aspect, in accordance with some implementations, the disclosure describes a network element, the network element comprising: an embedded device comprising a processor; a communication device in communication with the embedded device and operable to communicate via a communication network; and a non-transitory computer readable medium storing a server interface comprising processor-executable code that when executed causes the processor to: establish, with the communication device, a connection with a remote network element in the transport network; and responsive to receiving a SUBSCRIBE request from the remote network element via the connection: initialize a data collector operable to continually copy, at a predetermined data collection rate, a value stored at a location in a database, the location based at least in part on a target of the SUBSCRIBE request; store the value as a particular one of a plurality of responses; and transmit, at a predetermined data transmission rate, each of the plurality of responses to the remote network element via the connection.

Implementations of the above techniques include methods, apparatus, systems, and computer program products. One such computer program product is suitably embodied in a non-transitory machine-readable medium that stores instructions executable by one or more processors. The instructions are configured to cause the one or more processors to perform the above-described actions.

The details of one or more implementations of the subject matter of this specification are set forth in the accompanying drawings and the description below. Other aspects, features and advantages will become apparent from the description, the drawings, and the claims.

### BRIEF DESCRIPTION OF THE DRAWINGS

The accompanying drawings, which are incorporated in and constitute a part of this specification, illustrate one or more implementations described herein and, together with the description, explain these implementations. The drawings are not intended to be drawn to scale, and certain features and certain views of the figures may be shown exaggerated, to scale or in schematic in the interest of clarity and conciseness. Not every component may be labeled in every drawing. Like reference numerals in the figures may represent and refer to the same or similar element or function. In the drawings:

FIG. 1 is a diagram of an exemplary embodiment of a system for implementing a client-server architecture constructed in accordance with the present disclosure;

FIG. 2 is a diagram of an exemplary embodiment of a user device of the system shown in FIG. 1;

FIG. 3 is a diagram of an exemplary embodiment of a cloud-based server of the system shown in FIG. 1;

FIG. 4 is a diagram of an exemplary embodiment of a network element of the system shown in FIG. 1;

FIG. 5 is a diagram of an exemplary embodiment of an embedded device of the network element shown in FIG. 4;

FIG. 6 is a diagram of an exemplary embodiment of a controller card of the embedded device shown in FIG. 5;

FIG. 7 is a diagram of an exemplary embodiment of a prior art system for implementing a client-server architecture;

FIG. 8 is a diagram of an exemplary embodiment of the system shown in FIG. 1;

FIG. 9 is a process flow diagram of an exemplary embodiment of a client method and a corresponding server method according to the present disclosure;

FIG. 10 is a process flow diagram of an exemplary embodiment of a client method and a corresponding server method according to the present disclosure;

FIG. 11 is a process flow diagram of a server method according to the present disclosure; and

FIG. 12 is a process flow diagram of a server method according to the present disclosure.

### DETAILED DESCRIPTION

The following detailed description of example embodiments refers to the accompanying drawings. The same reference numbers in different drawings may identify the same or similar elements.

Before explaining at least one embodiment of the disclosure in detail, it is to be understood that the disclosure is not limited in its application to the details of construction, experiments, exemplary data, and/or the arrangement of the components set forth in the following description or illustrated in the drawings unless otherwise noted.

The disclosure is capable of other embodiments or of being practiced or carried out in various ways. Also, it is to be understood that the phraseology and terminology employed herein is for purposes of description and should not be regarded as limiting.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concept. This description should be read to include one or more and the singular also includes the plural unless it is obvious that it is meant otherwise. Further, use of the term “plurality” is meant to convey “more than one” unless expressly stated to the contrary.

As used herein, qualifiers like “about,” “approximately,” and combinations and variations thereof, are intended to include not only the exact amount or value that they qualify, but also some slight deviations therefrom, which may be due to manufacturing tolerances, measurement error, wear and tear, stresses exerted on various parts, and combinations thereof, for example.

As used herein, the term “substantially” means that the subsequently described parameter, event, or circumstance completely occurs or that the subsequently described parameter, event, or circumstance occurs to a great extent or degree. For example, the term “substantially” means that the subsequently described parameter, event, or circumstance occurs at least 90% of the time, or at least 91%, or at least 92%, or at least 93%, or at least 94%, or at least 95%, or at least 96%, or at least 97%, or at least 98%, or at least 99%, of the time, or means that the dimension or measurement is within at least 90%, or at least 91%, or at least 92%, or at least 93%, or at least 94%, or at least 95%, or at least 96%, or at least 97%, or at least 98%, or at least 99%, of the referenced dimension or measurement.

The use of the term “at least one” or “one or more” will be understood to include one as well as any quantity more than one. In addition, the use of the phrase “at least one of X, Y, and Z” will be understood to include X alone, Y alone, and Z alone, as well as any combination of X, Y, and Z.

The use of ordinal number terminology (i.e., “first”, “second”, “third”, “fourth”, etc.) is solely for the purpose of differentiating between two or more items and, unless explicitly stated otherwise, is not meant to imply any sequence or order or importance to one item over another or any order of addition.

As used herein, any reference to “one embodiment,” “an embodiment,” “some embodiments,” “one example,” “for example,” or “an example” means that a particular element, feature, structure, or characteristic described in connection with the embodiment is included in at least one embodiment and may be used in conjunction with other embodiments. The appearance of the phrase “in some embodiments” or “one example” in various places in the specification is not necessarily all referring to the same embodiment, for example.

Where a range of numerical values is recited or established herein, the range includes the endpoints thereof and all the individual integers and fractions within the range, and also includes each of the narrower ranges therein formed by all the various possible combinations of those endpoints and internal integers and fractions to form subgroups of the larger group of values within the stated range to the same extent as if each of those narrower ranges was explicitly recited. Where a range of numerical values is stated herein as being greater than a stated value, the range is nevertheless finite and is bounded on its upper end by a value that is operable within the context of the invention as described herein. Where a range of numerical values is stated herein as being less than a stated value, the range is nevertheless bounded on its lower end by a non-zero value. It is not intended that the scope of the invention be limited to the specific values recited when defining a range. All ranges are inclusive and combinable.

When values are expressed as approximations, e.g., by use of the antecedent “about,” it will be understood that the particular value forms another embodiment. Reference to a particular numerical value includes at least that particular value unless the context clearly dictates otherwise. The term “about” when used in reference to numerical ranges, cutoffs, or specific values is used to indicate that the recited values may vary by up to as much as 10% from the listed value. Thus, the term “about” is used to encompass variations of ±10% or less, variations of ±5% or less, variations of ±1% or less, variations of ±0.5% or less, or variations of ±0.1% or less from the specified value.

Circuitry, as used herein, may be analog and/or digital components, or one or more suitably programmed processors (e.g., microprocessors) and associated hardware and software, or hardwired logic. Also, “components” may perform one or more functions. The term “component” may include hardware, such as a processor (e.g., microprocessor), a combination of hardware and software, and/or the like. Software may include one or more computer executable instructions that when executed by one or more components cause the component to perform a specified function. It should be understood that the algorithms described herein may be stored on one or more non-transitory memory. Exemplary non-transitory memory may include random access memory, read only memory, flash memory, and/or the like. Such non-transitory memory may be electrically based, optically based, and/or the like.

Software may include one or more computer readable instruction that when executed by one or more component, e.g., a processor, causes the component to perform a specified function. It should be understood that the algorithms described herein may be stored on one or more non-transitory computer readable medium. Exemplary non-transitory computer readable mediums may include random access memory (RAM), a read only memory (ROM), and/or a non-volatile memory such as, for example, a CD-ROM, a hard drive, a solid-state drive, a flash drive, a memory card, a DVD-ROM, a Blu-ray Disk, a disk, an optical drive, combinations thereof, and/or the like.

Such non-transitory computer readable media may be electrically based, optically based, magnetically based, and/or the like. Further, the messages described herein may be generated by the components and result in various physical transformations.

As used herein, the terms “network—based,” “cloud-based,” and any variations thereof, are intended to include the provision of configurable computational resources on demand via interfacing with a computer and/or computer network, with software and/or data at least partially located on a computer and/or computer network.

As used herein, a “route” and/or an “optical route” may correspond to an optical path and/or an optical light path. For example, an optical route may specify a path along which light is carried between two or more network entities.

Users of optical networks may want to determine information associated with the optical network. Optical network information may be difficult to obtain, aggregate, and display. Implementations described herein assist a user in obtaining and viewing aggregated optical network information, such as network information associated with network entities and optical links between the network entities.

As used herein, an optical link may be an optical fiber, an optical channel, an optical super-channel, a super-channel group, an optical carrier group, a set of spectral slices, an optical control channel (e.g., sometimes referred to herein as an optical supervisory channel, or an “OSC”), an optical data channel (e.g., sometimes referred to herein as “BAND”), and/or any other optical signal transmission link.

In some implementations, an optical link may be an optical super-channel. A super-channel may include multiple channels multiplexed together using wavelength-division multiplexing in order to increase transmission capacity. Various quantities of channels may be combined into super-channels using various modulation formats to create different super-channel types having different characteristics. Additionally, or alternatively, an optical link may be a super-channel group. A super-channel group may include multiple super-channels multiplexed together using wavelength-division multiplexing in order to increase transmission capacity.

Additionally, or alternatively, an optical link may be a set of spectral slices. A spectral slice (a “slice”) may represent a spectrum of a particular size in a frequency band (e.g., 12.5 gigahertz (“GHz”), 6.25 GHz, etc.). For example, a 4.8 terahertz (“THz”) frequency band may include 382 spectral slices, where each spectral slice may represent 12.5 GHz of the 4.8 THz spectrum. A super-channel may include a different quantity of spectral slices depending on the super-channel type.

The generation of laser beams for use as optical data carrier signals is explained, for example, in U.S. Pat. No. 8,155,531, entitled “Tunable Photonic Integrated Circuits”, issued Apr. 10, 2012, and U.S. Pat. No. 8,639,118, entitled “Wavelength division multiplexed optical communication system having variable channel spacings and different modulation formats,” issued Jan. 28, 2014, which are hereby fully incorporated in their entirety herein by reference.

Referring now to the drawings, and in particular to FIG. 1, shown therein is a diagram of an exemplary embodiment of a system 10 for implementing a client-server architecture constructed in accordance with the present disclosure. A user 14 may interact with the system 10 using a user device 18 that may be used to send a configuration to one or more network element 22 (e.g., a first node 22a, a second node 22b, and/or a cloud-based server 22c) of a transport network 26. The user device 18 may communicate with the transport network 26 via a communication network 34.

In some embodiments, the cloud-based server 22c may comprise a processor and a memory having a data lake that may store copies of data such as sensor data, system data, metrics, logs, tracing, etc. in a raw format as well as transformed data that may be used for tasks such as reporting, visualization, analytics etc. The data lake may include structured data from relational databases, semi-structured data, unstructured data, time-series data, and binary data. The data lake may be a data base, a remote accessible storage, or a distributed file system.

In some embodiments, the communication network 34 may be the Internet and/or another network. For example, if the communication network 34 is the Internet, a primary user interface of the system 10 may be delivered through a series of web pages or private internal web pages of a company or corporation, which may be written in hypertext markup language, and accessible by the user device 18. It should be noted that the primary user interface of the system 10 may be another type of interface including, but not limited to, a Windows-based application, a tablet-based application, a mobile web interface, an application running on a mobile device, and/or the like.

The communication network 34 may be almost any type of network. For example, in some embodiments, the communication network 34 may be a version of an Internet network (e.g., exist in a TCP/IP-based network). In one embodiment, the communication network 34 is the Internet. It should be noted, however, that the communication network 34 may be almost any type of network and may be implemented as the World Wide Web (or Internet), a local area network (LAN), a wide area network (WAN), a metropolitan network, a wireless network, a cellular network, a Bluetooth network, a Global System for Mobile Communications (GSM) network, a code division multiple access (CDMA) network, a 3G network, a 4G network, an LTE network, a 5G network, a satellite network, a radio network, an optical network, a cable network, a public switched telephone network, an Ethernet network, combinations thereof, and/or the like. It is conceivable that in the near future, embodiments of the present disclosure may use more advanced networking topologies.

The transport network 26 may be, for example, a packet transport network (such as IP, MPLS, or MPLS-TP packet transport networks) and/or an optical transport network (such as OTN or WDM transport networks). The transport network 26 may be considered as a graph made up of interconnected individual nodes (that is, the network elements 22 and/or the cloud-based server 22c). If the transport network 26 is an optical transport network, the transport network 26 may include any type of network that uses light as a transmission medium. For example, the transport network 26 may include a fiber-optic based network, an optical transport network, a light-emitting diode network, a laser diode network, an infrared network, combinations thereof, and/or other types of optical networks.

The number of devices and/or networks illustrated in FIG. 1 is provided for explanatory purposes. In practice, there may be additional devices and/or networks, fewer devices and/or networks, different devices and/or networks, or differently arranged devices and/or networks than are shown in FIG. 1. Furthermore, two or more of the devices illustrated in FIG. 1 may be implemented within a single device, or a single device illustrated in FIG. 1 may be implemented as multiple, distributed devices. Additionally, or alternatively, one or more of the devices of system 10 may perform one or more functions described as being performed by another one or more of the devices of the system 10. Devices of the system 10 may interconnect via wired connections, wireless connections, or a combination thereof.

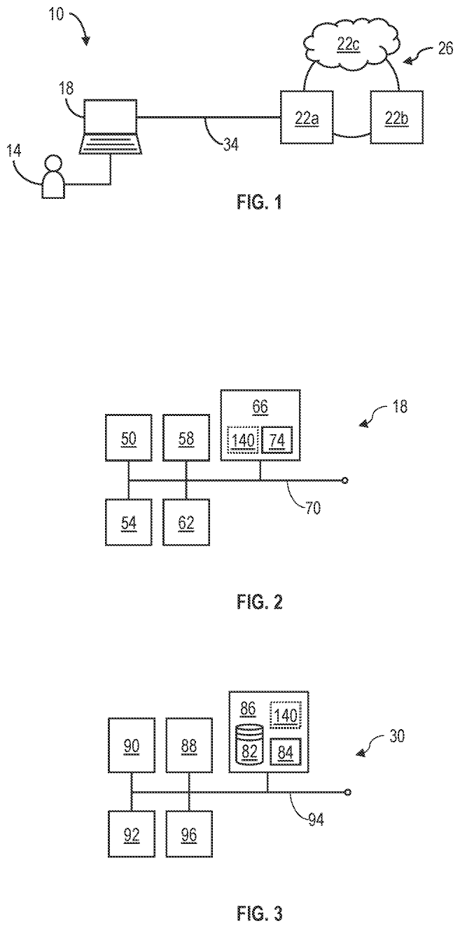

Referring now to FIG. 2, shown therein is a diagram of an exemplary embodiment of the user device 18 of the system 10 constructed in accordance with the present disclosure. In some embodiments, the user device 18 may include, but is not limited to, implementations as a personal computer, a cellular telephone, a smart phone, a network-capable television set, a tablet, a laptop computer, a desktop computer, a network-capable handheld device, a server, a digital video recorder, a wearable network-capable device, a virtual reality / augmented reality device, and/or the like.

In some embodiments, the user device 18 may include one or more input device 50 (hereinafter “input device 50”), one or more output device 54 (hereinafter “output device 54”), one or more processor 58 (hereinafter “processor 58”), one or more communication device 62 (hereinafter “communication device 62”) capable of interfacing with the communication network 34, one or more non-transitory computer-readable memory 66 (hereinafter “memory 66”) storing processor-executable code and/or software application(s), for example including, a web browser capable of accessing a website and/or communicating information and/or data over a wireless or wired network (e.g., the communication network 34), and/or the like. The input device 50, the output device 54, the processor 58, the communication device 62, and the memory 66 may be connected via a path 70 such as a data bus that permits communication among the components of the user device 18.

The memory 66 may store an application 74 that, when executed by the processor 58 causes the user device 18 to perform an action such as communicate with or control one or more component of the user device 18 and/or the communication network 34. In some embodiments, the memory 66 may store a plurality of client applications 140 (hereinafter “client applications 140”) (to be discussed in greater detail below).

The input device 50 may be capable of receiving information input from the user 14 and/or the processor 58, and transmitting such information to other components of the user device 18 and/or the communication network 34. The input device 50 may include, but is not limited to, implementation as a keyboard, a touchscreen, a mouse, a trackball, a microphone, a camera, a fingerprint reader, an infrared port, a slide-out keyboard, a flip-out keyboard, a cell phone, a PDA, a remote control, a fax machine, a wearable communication device, a network interface, combinations thereof, and/or the like, for example.

The output device 54 may be capable of outputting information in a form perceivable by the user 14 and/or the processor 58. For example, implementations of the output device 54 may include, but are not limited to, a computer monitor, a screen, a touchscreen, a speaker, a website, a television set, a smart phone, a PDA, a cell phone, a fax machine, a printer, a laptop computer, a haptic feedback generator, combinations thereof, and the like, for example. It is to be understood that in some exemplary embodiments, the input device 50 and the output device 54 may be implemented as a single device, such as, for example, a touchscreen of a computer, a tablet, or a smartphone. It is to be further understood that as used herein the term user (e.g., the user 14) is not limited to a human being, and may comprise a computer, a server, a website, a processor, a network interface, a user terminal, a virtual computer, combinations thereof, and/or the like, for example.

The communication network 34 may permit bi-directional communication of information and/or data between the user device 18, the cloud-based server 22c, and/or the network elements 22. The communication network 34 may interface with the cloud-based server 22c, the user device 18, and/or the network elements 22 in a variety of ways. For example, in some embodiments, the communication network 34 may interface by optical and/or electronic interfaces, and/or may use a plurality of network topographies and/or protocols including, but not limited to, Ethernet, TCP/IP, circuit switched path, combinations thereof, and/or the like. The communication network 34 may utilize a variety of network protocols to permit bi-directional interface and/or communication of data and/or information between the cloud-based server 22c, the user device 18 and/or the network elements 22.

Referring now to FIG. 3, shown therein is a diagram of an exemplary embodiment of the cloud-based server 22c constructed in accordance with the present disclosure. In the illustrated embodiment, the cloud-based server 22c is provided with one or more database 82 (hereinafter “database 82”), one or more server interface 84 (hereinafter “server interface 84”), and one or more processor 88 (hereinafter “processor 88”). The server interface 84 and the database 82 are stored on a non-transitory computer-readable medium 86 (hereinafter “memory 86”) accessible by the processor 88 of the cloud-based server 22c. In some embodiments, the database 82 may be a time series database. The database 82 may be a relational database or a non-relational database. Examples of such databases comprise, DB2®, Microsoft® Access, Microsoft® SQL Server, Oracle®, mySQL, PostgreSQL, MongoDB, Apache Cassandra, InfluxDB, Prometheus, Redis, Elasticsearch, TimescaleDB, and/or the like. It should be understood that these examples have been provided for the purposes of illustration only and should not be construed as limiting the presently disclosed inventive concepts. The database 82 can be centralized or distributed across multiple systems.

In some embodiments, the cloud-based server 22c may comprise one or more processor 88 working together, or independently to, execute processor-executable code, such as the server interface 84, stored on the memory 86. Additionally, each cloud-based server 22c may include at least one input device 90 (hereinafter “input device 90”) and at least one output device 92 (hereinafter “output device 92”). Each element of the cloud-based server 22c may be partially or completely network-based or cloud-based, and may or may not be located in a single physical location.

The processor 88 may be implemented as a single processor or multiple processors working together, or independently, to execute the server interface 84 as described herein. It is to be understood, that in certain embodiments using more than one processor 88, the processors 88 may be located remotely from one another, located in the same location, or comprising a unitary multi-core processor. The processors 88 may be capable of reading and/or executing processor-executable code and/or capable of creating, manipulating, retrieving, altering, and/or storing data structures into the memory 86.

Exemplary embodiments of the processor 88 may include, but are not limited to, a digital signal processor (DSP), a central processing unit (CPU), a field programmable gate array (FPGA), a microprocessor, a multi-core processor, an application specific integrated circuit (ASIC), combinations, thereof, and/or the like, for example. The processor 88 may be capable of communicating with the memory 86 via a path 94 (e.g., data bus). The processor 88 may be capable of communicating with the input device 90 and/or the output device 92.

The processor 88 may be further capable of interfacing and/or communicating with the user device 18 and/or the network elements 22 via the communication network 34 using a communication device 96. For example, the processor 88 may be capable of communicating via the communication network 34 by exchanging signals (e.g., analog, digital, optical, and/or the like) via one or more ports (e.g., physical or virtual ports) using a network protocol to provide updated information to the application 74 executed on the user device 18.

The memory 86 may be implemented as a conventional non-transitory memory, such as for example, random access memory (“RAM”), CD-ROM, a hard drive, a solid-state drive, a flash drive, a memory card, a DVD-ROM, a disk, an optical drive, combinations thereof, and/or the like, for example.

In some embodiments, the memory 86 may be located in the same physical location as the cloud-based server 22c, and/or one or more memory 86 may be located remotely from the cloud-based server 22c. For example, the memory 86 may be located remotely from the cloud-based server 22c and communicate with the processor 88 via the communication network 34. Additionally, when more than one memory 86 is used, a first memory 86 may be located in the same physical location as the processor 88, and additional memory 86 may be located in a location physically remote from the processor 88. Additionally, the memory 86 may be implemented as a “cloud” non-transitory computer-readable storage memory (i.e., one or more memory 86 may be partially or completely based on or accessed using the communication network 34).

The input device 90 of the cloud-based server 22c may transmit data to the processor 88 and may be similar to the input device 50 of the user device 18. The input device 90 may be located in the same physical location as the processor 88, or located remotely and/or partially or completely network-based. The output device 92 of the cloud-based server 22c may transmit information from the processor 88 to the user 12, and may be similar to the output device 54 of the user device 18. The output device 92 may be located with the processor 88, or located remotely and/or partially or completely network-based.

The memory 86 may store processor-executable code and/or information comprising the database 82 and the server interface 84. In some embodiments, the server interface 84 may be stored as a data structure, such as the database 82 and/or data table, for example, or in non-data structure format such as in a non-compiled text file. In some embodiments, the memory 86 may store the client applications 140 (to be discussed in greater detail below).

The network elements 22 may include one or more devices that gather, process, store, and/or provide information in response to a request in a manner described herein. For example, the network elements 22 may include one or more optical data processing and/or traffic transfer devices, such as an optical node, an optical amplifier (e.g., a doped fiber amplifier, an erbium doped fiber amplifier, a Raman amplifier, etc.), an optical add-drop multiplexer (“OADM”), a reconfigurable optical add-drop multiplexer (“ROADM”), a flexibly reconfigurable optical add-drop multiplexer module (“FRM”), an optical source component (e.g., a laser source, or optical laser), an optical source destination (e.g., a laser sink), an optical multiplexer, an optical demultiplexer, an optical transmitter, an optical receiver, an optical transceiver, a photonic integrated circuit, an integrated optical circuit, a computer, a server, a router, a bridge, a gateway, a modem, a firewall, a switch, a network interface card, a hub, and/or any type of device capable of processing and/or transferring optical traffic.

In some implementations, the network elements 22 may include OADMs and/or ROADMs capable of being configured to add, drop, multiplex, and demultiplex optical signals.

The network elements 22 may process and transmit optical signals to other network elements 22 throughout transport network 26 in order to deliver optical transmissions.

Layer 1 specific embodiments of the network elements 22 may optionally be provided with additional elements that are not shown in the Figures such as an optical transceiver, a digital signal processor (DSP), and an additional high-speed integrated circuit (ASIC or FPGA) that is specialized to handle high-speed data frames/packets.

Layer 0 specific embodiments of the network elements 22 may optionally be provided with additional elements that are not shown in the Figures such as a Wavelength Selective Switch (WSS), Variable Optical Attenuator (VOA), Erbium Doped Fiber Amplifier (EDFA), or Raman amplifiers, and optical channel monitors, for instance.

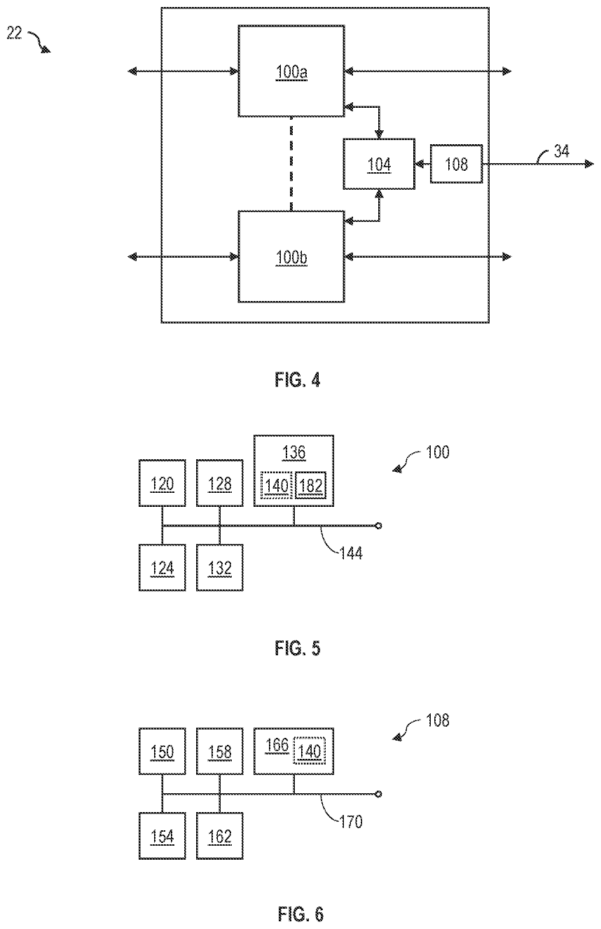

Referring now to FIG. 4, shown therein is a diagram of an exemplary embodiment of the network element 22, such as the first node 22a and/or the second node 22b of FIG. 1, constructed in accordance with the present disclosure. The network element 22 generally comprises an embedded device 100 (shown as embedded device 100a and embedded device 100b), a communication device 104 to allow one or more component of the network element 22 to communicate to one or more other component of the network element 22 or to another network element 22 in the system 10 via the communication network 34, and a controller card 108.

In one embodiment, the embedded device 100 includes one or more digital coherent optics module having one or more coherent optical transceiver operable to receive client data from an electrical signal and transmit the client data in an optical signal and/or receive the client data from an optical signal and transmit the client data in an electrical signal, or a combination thereof. In one embodiment, the embedded device 100 may include one or more of the Layer 1 elements and/or Layer 0 elements as detailed above. The embedded optical device may have one or more property affecting a function of the embedded device and one or more status indicative of a current state of at least one component of the embedded device.

In accordance with the present disclosure, a network element 22 may be a holder, like a chassis, or a contained/logical equipment, like an optical line card within the chassis. In one embodiment, the network element 22 may be a logical entity comprising one or more chassis having one or more pluggable cards (such as one or more embedded device 100 and/or one or more controller card 108) that form the network element 22. For instance, pluggable cards may include traffic carrying (“data plane”) cards (e.g., embedded device 100) that may have customized silicon such as ASICs or FPGAs that process the data plane frames/packets, based on the functionality of the card. Another exemplary traffic carrying card is a router line-card which has packet processing ASICs or other specialized silicon. Another exemplary embedded device 100 is an optical line card that includes a DSP module and/or optical photonic circuits. Pluggable cards may also refer to controller cards (“control and management plane”) that do not process data packets but run all the software that implement the control plane (routing protocols) and management plane (management interfaces such as CLI, NETCONF, gRPC, DHCP etc.) such as the controller card 108. The controller card 108 typically has an off-the-shelf CPU (such as Intel or ARM) and run some variant of an operating system (more recently, Linux or QNX or BSD), described below in more detail. Other embedded devices 100 include common cards that may also be added such as fan trays, power entry modules, and others that provide auxiliary functions of the chassis.

It should be noted that the diagram of the network element 22 in FIG. 4 is simplified to include one controller card 108 in communication with multiple embedded devices 100. It is understood that the network element 22 may include more than one controller card 108, and each controller card 108 may be in communication with one or more embedded device 100 via the same or a different communication device 104.

The number of devices illustrated in FIG. 4 is provided for explanatory purposes. In practice, there may be additional devices, fewer devices, different devices, or differently arranged devices than are shown in FIG. 4. Furthermore, two or more of the devices illustrated in FIG. 4 may be implemented within a single device, or a single device illustrated in FIG. 4 may be implemented as multiple, distributed devices. Additionally, one or more of the devices illustrated in FIG. 4 may perform one or more functions described as being performed by another one or more of the devices illustrated in FIG. 4. Devices illustrated in FIG. 4 may interconnect via wired connections (e.g., fiber-optic connections).

Referring now to FIG. 5, shown therein is an exemplary embodiment of the embedded device 100 constructed in accordance with the present disclosure. In some embodiments, the embedded device 100 may include, but is not limited to, one or more input device 120 (hereinafter “input device 120”), one or more output device 124 (hereinafter “output device 124”), one or more processor 128 (hereinafter “processor 128”), one or more communication device 132 (hereinafter “communication device 132”) operable to interface with the communication device 104, one or more non-transitory computer-readable medium 136 (hereinafter “memory 136”) storing processor-executable code and/or a common client interface 182 (to be discussed in greater detail below). The input device 120, the output device 124, the processor 128, the communication device 132, and the memory 136 may be connected via a path 144 such as a data bus that permits communication among the components of the embedded device 100.

The input device 120 may be capable of receiving client data and transmitting the client data to other components of the system 10. The input device 120 may include, but is not limited to, implementation as an optical network interface, an electrical network interface, combinations thereof, and/or the like, for example.

The output device 124 may be capable of outputting client data. For example, implementations of the output device 124 may include, but are not limited to, implementation as an optical network interface, an electrical network interface, combinations thereof, and/or the like, for example.

In some embodiments, the memory 136 may store the client applications 140 (to be discussed in greater detail below).

Referring now to FIG. 6, shown therein is an exemplary embodiment of the controller card 108 constructed in accordance with the present disclosure. In some embodiments, the controller card 108 may include, but is not limited to, one or more input device 150 (hereinafter “input device 150”), one or more output device 154 (hereinafter “output device 154”), one or more processor 158 (hereinafter “processor 158”), one or more communication device 162 (hereinafter “communication device 162”) operable to interface with the communication device 104, one or more non-transitory memory 166 (hereinafter “memory 166”) storing processor-executable code and/or software application(s). The input device 150, output device 154, processor 158, communication device 162, and memory 166 may be connected via a path 170 such as a data bus that permits communication among the components of the controller card 108.

The input device 150 may be capable of receiving client data and transmitting the client data to other components of the system 10. The input device 150 may include, but is not limited to, implementation as an optical network interface, an electrical network interface, combinations thereof, and/or the like, for example.

The output device 154 may be capable of outputting client data. For example, implementations of the output device 154 may include, but are not limited to, implementation as an optical network interface, an electrical network interface, combinations thereof, and/or the like, for example.

In some embodiments, the memory 166 may store the client applications 140 (to be discussed in greater detail below).

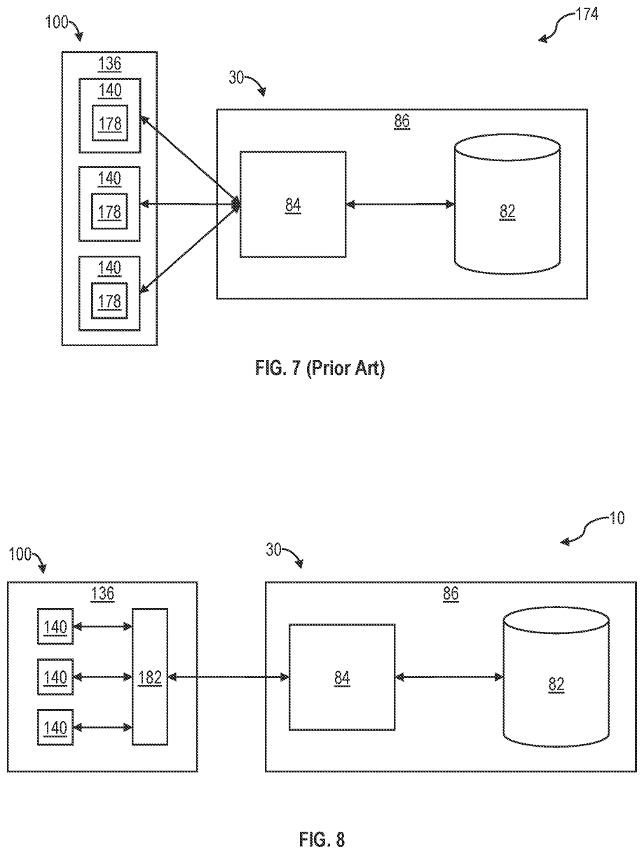

Referring now to FIG. 7, shown therein is a diagram of a prior art system for implementing a client-server architecture 174. In the prior art system 174, each of the client applications 140 is provided with a client interface 178 comprising computer executable instructions for interfacing with one or more component of the cloud-based server 22c, such as the database 82 and/or the server interface 84. In the prior art system 174, the client interface 178 is duplicative. This duplication of the client interface 178 across each of the client applications 140 consumes memory and storage excessively. Furthermore, developing each of the client applications 140 as such requires an excessive amount of time.

Referring now to FIG. 8, shown therein is a diagram of the exemplary embodiment of the system 10 shown in FIG. 1. In the presently described system 10, the memory 136 of the embedded device 100 stores the common client interface 182 comprising computer executable instructions for providing a framework for interfacing between the client applications 140 and one or more component of the cloud-based server 22c, such as the database 82 and/or the server interface 84. In the presently described system 10, the common client interface 182 interfaces with each of the client applications 140. Having only one common client interface 182 preserves memory and storage. Furthermore, developing each of the client applications 140 as such requires comparatively less time.

While the client applications 140 are depicted in FIGS. 7 and 8 as being stored by the memory 136, it should be understood that the client applications 140 may be stored by any memory (e.g., the memory 66, the memory 86, the memory 136, and/or the memory 166).

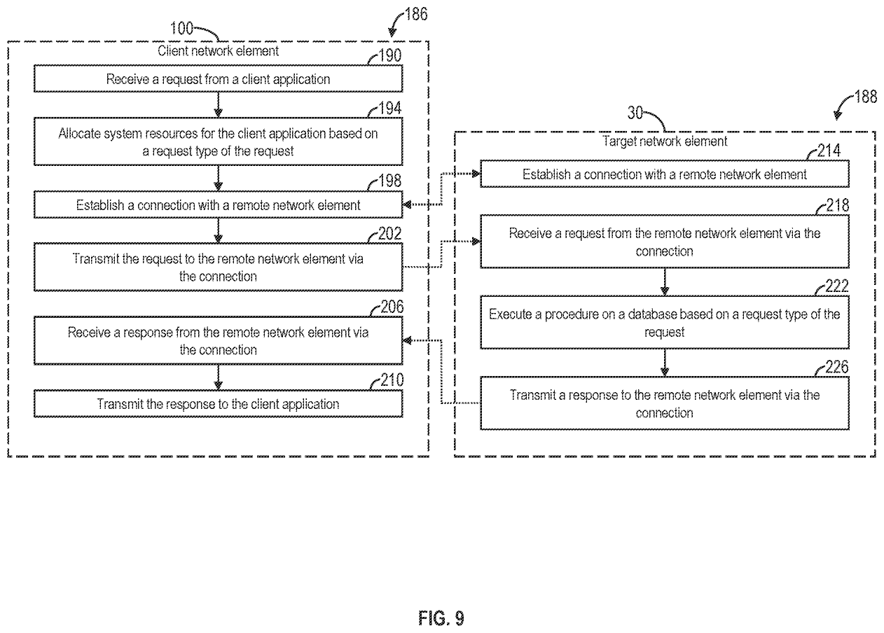

Referring now to FIG. 9, shown therein is a process flow diagram of an exemplary embodiment of a client method 186a and a corresponding server method 188 according to the present disclosure.

The client method 186a is generally included in the computer executable instructions of the common client interface 182 and generally includes the steps of: receiving a request from a particular one of the client applications 140, wherein the request comprises a request type (step 190); responsive to receiving the request from the particular one of the client applications 140, performing a request routine comprising: allocating one or more system resource (hereinafter “system resources”) for the particular one of the client applications 140, the system resources based at least in part on the request type of the request (step 194); establishing, with the communication device 104 communicating via the communication network 34, a connection with a remote network element (i.e., the network elements 22 and/or the cloud-based server 22c) in the transport network 26 (step 198); transmitting, via the connection, the request to the remote network element (i.e., the network elements 22 and/or the cloud-based server 22c) (step 202); receiving, via the connection, a response from the remote network element (i.e., the network elements 22 and/or the cloud-based server 22c) (step 206); and transmitting, via the connection, the response to the particular one of the client applications 140 (step 210).

In some embodiments, the request is one of a GET request, a SET request, and a SUBSCRIBE request. Where the request is a SUBSCRIBE request, the step of receiving, via the connection, a response from the remote network element (i.e., the network elements 22 and/or the cloud-based server 22c) (step 206) comprises receiving, at a predetermined data transmission rate, a plurality of responses from the remote network element (i.e., the network elements 22 and/or the cloud-based server 22c) via the connection; and transmitting, via the connection, the plurality of responses to the particular one of the client applications 140 (step 210). In some embodiments, the client method 186 further comprises: receiving an UNSUBSCRIBE request from the particular one of the client applications 140; and responsive to receiving the UNSUBSCRIBE request from the particular one of the client applications 140, de-allocating the system resources allocated for the particular one of the client applications 140.

In some embodiments, the system resources comprise one or more of a computing resource, a networking resource, a memory resource, and a storage resource. In some embodiments, allocating computing resources for the particular one of the client applications 140 comprises at least one of assigning a computing priority to the particular one of the client applications 140 and binding the particular one of the client applications 140 to a processor (i.e., the processor 58, the processor 88, the processor 128, and/or the processor 158). In some embodiments, the computing priority may be indicative of a processor runtime to be allocated to the particular one of the client applications 140; that is, the computing priority may cause a processor (i.e., the processor 58, the processor 88, the processor 128, and/or the processor 158) to execute the particular one of the client applications 140 for a predetermined time period. In some embodiments, allocating network resources for the particular one of the client applications 140 comprises opening one or more socket for the particular one of the client applications 140. In some embodiments, allocating memory resources for the particular one of the client applications 140 comprises allocating one or more byte of the memory (i.e., the memory 66, the memory 86, the memory 136, and/or the memory 166) for the particular one of the client applications 140. In some embodiments, allocating storage resources for the particular one of the client applications 140 comprises allocating one or more byte of the memory (i.e., the memory 66, the memory 86, the memory 136, and/or the memory 166) for the particular one of the client applications 140.

In some embodiments, the connection comprises a Hypertext Protocol Version 2 (“HTTP/2”) connection. However, in other embodiments, the connection may be any type of network connection that is capable of performing the described invention.

In some embodiments, the step of establishing, with the communication device 104 communicating via the communication network 34, the connection with the remote network element (i.e., the network elements 22 and/or the cloud-based server 22c) in the transport network 26 (step 198) comprises: transmitting, with the communication device 104 communicating via the communication network 34, a client greeting message to the remote network element (i.e., the network elements 22 and/or the cloud-based server 22c) in the transport network 26; receiving, with the communication device 104 communicating via the communication network 34, a server greeting message from the remote network element (i.e., the network elements 22 and/or the cloud-based server 22c) in the transport network 26, the server greeting message comprising a validation certificate; and validating the validation certificate. In some embodiments, the validation certificate is a Transport Layer Security (“TLS”) certificate.

In some embodiments, the request is a remote procedure call, and the response is a remote procedure response. In some embodiments, the request is a gRPC call, and the response is a gRPC response.

In some embodiments, the client method 182a further comprises: encoding the request in a predetermined serialized data format; and decoding the response from the predetermined serialized data format. In some embodiments, the predetermined serialized data format is a protocol buffer format. In some embodiments, the steps of encoding the request in a predetermined serialized data format and decoding the response from the predetermined serialized data format are performed by a network management interface. In some embodiments, the network management interface is a gNMI interface.

The server method 188 is generally included in the computer executable instructions of the server interface 84 and generally includes the steps of: establishing, with the communication device 96 communicating via the communication network 34, a connection with a remote network element (i.e., the network elements 22) in the transport network 26 (step 214); receiving, via the connection, a request from the remote network element (i.e., the network elements 22) (step 218); responsive to receiving the request from the remote network element (i.e., the network elements 22), executing a procedure on a database 82 based at least in part on a request type of the request (step 226); and transmitting, via the connection, a response to the remote network element (i.e., the network elements 22), the response being indicative of a status of the database 82 (step 230).

In some embodiments, the request is a GET request, and the procedure is a GET procedure comprising the steps of: copying a value stored at a location on the database 82, the location based at least in part on a target of the request; and storing the value as the response.

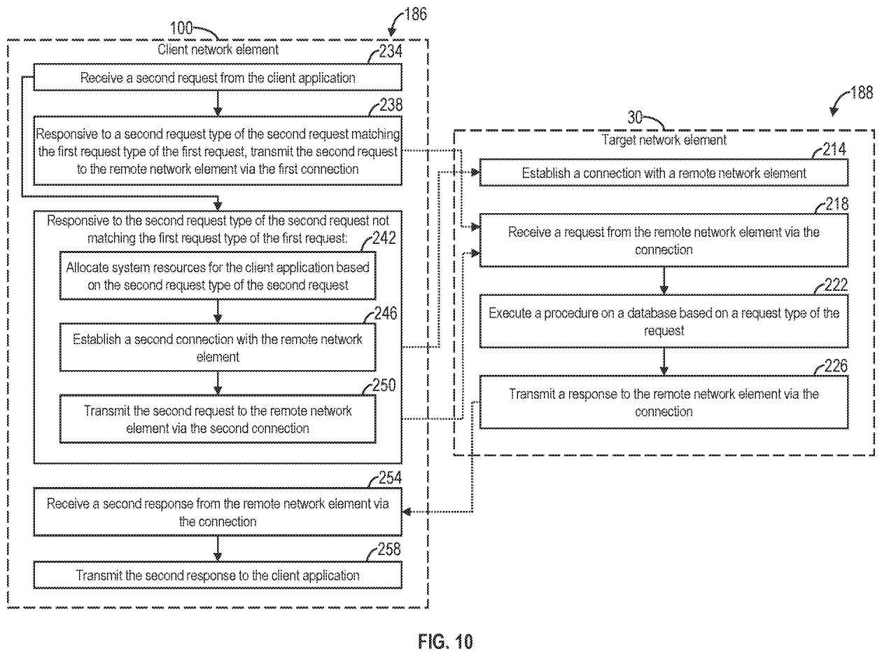

In some embodiments, the request is a SET request, and the procedure is a SET procedure comprising the steps of: storing a request value of the request at a location on the database 82, the location based at least in part on a target of the request; and storing data indicative of a status of the database 82 as the result. In some embodiments, the data indicative of a status of the database 82 is data indicative of a success or a failure of the SET procedure. Referring now to FIG. 10, shown therein is a process flow diagram of an exemplary embodiment of a client method 186b and the corresponding server method 188 according to the present disclosure. In some embodiments, the client method 186b comprises: receiving, via the connection, a second request from the particular one of the client applications 140 (step 234); responsive to receiving the second request from the particular one of the client applications 140, performing a second request routine comprising: responsive to a second request type of the second request matching the first request type of the first request, transmitting, via the connection, the second request to the remote network element (i.e., the network elements 22 and/or the cloud-based server 22c) (step 234). Alternatively, responsive to the second request type of the second request not matching the first request type of the first request, the second request routine comprises: allocating one or more second system resource (hereinafter “second system resources”) for the particular one of the client applications 140, the second system resources based at least in part on the second request type of the second request (step 242); establishing, with the communication device 62 communicating via the communication network 34, a second connection with a remote network element (i.e., the network elements 22 and/or the cloud-based server 22c) in the transport network 26 (step 246); and transmitting, via the second connection, the second request to the remote network element (i.e., the network elements 22 and/or the cloud-based server 22c) (step 250).

In some embodiments, the second system resources comprise one or more of a computing resource, a networking resource, a memory resource, and a storage resource. In some embodiments, allocating computing resources for the particular one of the client applications 140 comprises at least one of assigning a computing priority to the particular one of the client applications 140 and binding the particular one of the client applications 140 to a processor (i.e., the processor 58, the processor 88, the processor 128, and/or the processor 158). In some embodiments, the computing priority may be indicative of a processor runtime to be allocated to the particular one of the client applications 140; that is, the computing priority may cause a processor (i.e., the processor 58, the processor 88, the processor 128, and/or the processor 158) to execute the particular one of the client applications 140 for a predetermined time period. In some embodiments, allocating network resources for the particular one of the client applications 140 comprises opening one or more socket for the particular one of the client applications 140. In some embodiments, allocating memory resources for the particular one of the client applications 140 comprises allocating one or more byte of the memory (i.e., the memory 66, the memory 86, the memory 136, and/or the memory 166) for the particular one of the client applications 140. In some embodiments, allocating storage resources for the particular one of the client applications 140 comprises allocating one or more byte of the memory (i.e., the memory 66, the memory 86, the memory 136, and/or the memory 166) for the particular one of the client applications 140.

In some embodiments, the client method 186b comprises: receiving, via at least one of the first connection and the second connection, a second response (step 254); and responsive to receiving the second response, transmitting the second response to the particular one of the client applications 140 (step 258).

In some embodiments, the second connection comprises a Hypertext Protocol Version 2 (“HTTP/2”) connection. However, in other embodiments, the second connection may be any type of network connection that is capable of performing the described invention.

In some embodiments, the step of establishing, with the communication device 62 communicating via the communication network 34, the second connection with the remote network element (i.e., the network elements 22 and/or the cloud-based server 22c) in the transport network 26 (step 246) comprises: transmitting, with the communication device 62 communicating via the communication network 34, a client greeting message to the remote network element (i.e., the network elements 22 and/or the cloud-based server 22c) in the transport network 26; receiving, with the communication device 62 communicating via the communication network 34, a server greeting message from the remote network element (i.e., the network elements 22 and/or the cloud-based server 22c) in the transport network 26, the server greeting message comprising a validation certificate; and validating the validation certificate. In some embodiments, the validation certificate is a Transport Layer Security (“TLS”) certificate.

In some embodiments, the second request is a remote procedure call, and the second response is a remote procedure response. In some embodiments, the second request is a gRPC call, and the second response is a gRPC response.

In some embodiments, the client method 182b further comprises: encoding the second request in a predetermined serialized data format; and decoding the second response from the predetermined serialized data format. In some embodiments, the predetermined serialized data format is a protocol buffer format.

Referring now to FIG. 11, shown therein is a process flow diagram of an exemplary embodiment of a server method 262a according to the present disclosure. In some embodiments, the server method 262a comprises: establishing, with the communication device 96 communicating via the communication network 34, a connection with a remote network element (i.e., the network elements 22) in the transport network 26 (step 266); receiving, via the connection, a SUBSCRIBE request from the remote network element (i.e., the network elements 22) (step 270); responsive to receiving, via the connection, the SUBSCRIBE request from the remote network element (i.e., the network elements 22): initializing a data collector operable to continually copy, at a predetermined data collection rate, a value stored at a location in a database 82, the location based at least in part on a target of the SUBSCRIBE request (step 274); storing the value as a particular one of a plurality of responses (step 278); and transmitting, at a predetermined data transmission rate, each of the plurality of responses to the remote network element (i.e., the network elements 22) via the connection (step 282).

In some embodiments, the SUBSCRIBE request is a remote procedure call, and each of the plurality of responses is a remote procedure response. In some embodiments, the SUBSCRIBE request is a gRPC call, and each of the plurality of responses is a gRPC response. In some embodiments, each of the SUBSCRIBE request and the plurality of responses is formatted in a protocol buffer format.

In some embodiments, the predetermined data collection rate is based at least in part on a data collection rate of the SUBSCRIBE request and the predetermined data transmission rate is based at least in part on a data transmission rate of the SUBSCRIBE request.

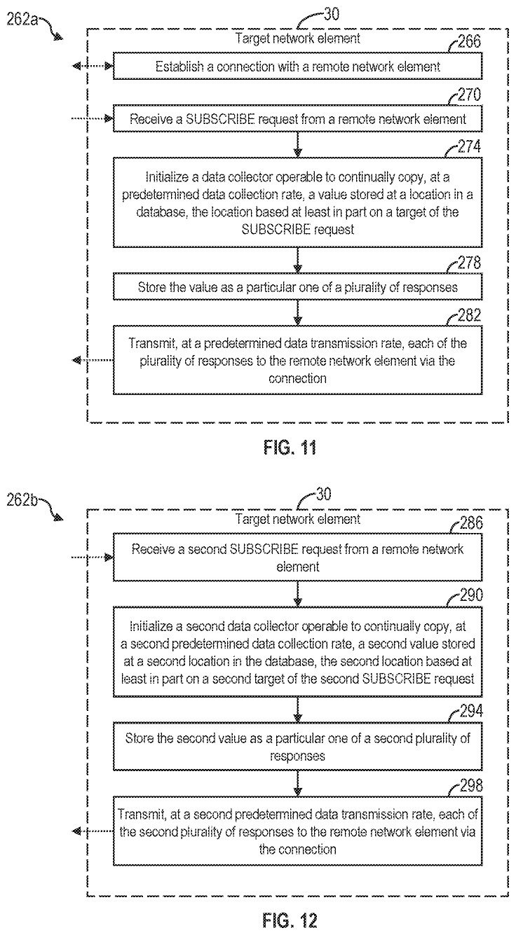

Referring now to FIG. 12, shown therein is a process flow diagram of an exemplary embodiment of a server method 262b according to the present disclosure. In some embodiments, the server method 262b comprises: receiving, via the connection, a second SUBSCRIBE request from the remote network element (i.e., the network elements 22) (step 286); responsive to receiving the second SUBSCRIBE request from the remote network element (i.e., the network elements 22) via the connection: initializing a second data collector operable to continually copy, at a second predetermined data collection rate, a second value stored at a second location in the database 82, the second location based at least in part on a second target of the second SUBSCRIBE request (step 290); storing the second value as a particular one of a second plurality of responses (step 278); and transmitting, at a second predetermined data transmission rate, each of the plurality of responses to the remote network element (i.e., the network elements 22) via the connection (step 298).

In some embodiments, the second SUBSCRIBE request is a remote procedure call, and each of the second plurality of responses is a remote procedure response. In some embodiments, the second SUBSCRIBE request is a gRPC call, and each of the second plurality of responses is a gRPC response. In some embodiments, each of the second SUBSCRIBE request and the second plurality of responses is formatted in a protocol buffer format.

In some embodiments, the second predetermined data collection rate is based at least in part on a second data collection rate of the second SUBSCRIBE request and the second predetermined data transmission rate is based at least in part on a second data transmission rate of the second SUBSCRIBE request.

From the above description, it is clear that the inventive concept(s) disclosed herein are well adapted to carry out the objects and to attain the advantages mentioned herein, as well as those inherent in the inventive concept(s) disclosed herein. While the embodiments of the inventive concept(s) disclosed herein have been described for purposes of this disclosure, it will be understood that numerous changes may be made and readily suggested to those skilled in the art which are accomplished within the scope and spirit of the inventive concept(s) disclosed herein.

What is claimed is:

1. A network element comprising:
an embedded device comprising a processor:
a communication device in communication with the embedded device and operable to communicate via a communication network; and
a non-transitory computer readable medium storing a common client interface comprising processor-executable code that when executed causes the processor to:
responsive to receiving a request from a particular one of a plurality of client applications:
allocate one or more system resource for the particular one of the plurality of client applications, the one or more system resource based at least in part on a request type of the request;
establish, with the communication device, a connection with a remote network element in a transport network; and
transmit the request to the remote network element via the connection; and
responsive to receiving a response from the remote network element via the connection, transmit the response to the particular one of the plurality of client applications.

2. The network element of claim 1, wherein the one or more system resource comprises one or more of a computing resource, a networking resource, a memory resource, and a storage resource.

3. The network element of claim 1, wherein the request is a remote procedure call, and the response is a remote procedure response.

4. The network element of claim 3, wherein the request is a gRPC call, and the response is a gRPC response.

5. The network element of claim 4, wherein the common client interface further comprises processor-executable code that when executed causes the processor to:
encode the request in a predetermined serialized data format; and
decode the response from the predetermined serialized data format.

6. The network element of claim 5, wherein the predetermined serialized data format is a protocol buffer format.

7. The network element of claim 1, wherein the request having the request type is a first request having a first request type, the one or more system resource is one or more first system resource, the connection is a first connection, the response is a first response, and the common client interface further comprises processor-executable code that when executed causes the processor to:
responsive to receiving a second request from the particular one of the plurality of client applications:
responsive to a second request type of the second request matching the first request type of the first request, transmit the second request to the remote network element via the first connection;
responsive to the second request type of the second request not matching the first request type of the first request:
allocate one or more second system resource for the particular one of the plurality of client applications based at least in part on the second request type of the second request;
establish, with the communication device, a second connection with the remote network element in the transport network; and
transmit the second request to the remote network element via the second connection; and
responsive to receiving a second response from the remote network element via the second connection, transmit the second response to the particular one of the plurality of client applications.

8. The network element of claim 1, wherein the transport network is an optical transport network.

9. The network element of claim 8, wherein the network element further comprises a digital coherent optics module having one or more coherent optical transceiver operable to transmit and/or receive client data in the optical transport network.

10. The network element of claim 1, wherein the processor is one or more of a digital signal processor, an application specific integrated circuit, a field programmable gate array, a microprocessor, and a central processing unit.

11. The network element of claim 1, wherein the embedded device is one or more of a Wavelength Selective Switch (WSS), a Variable Optical Attenuator (VOA), an Erbium Doped Fiber Amplifier (EDFA), an optical laser, a Raman amplifier, and an optical channel monitor.

12. A network element comprising:
an embedded device comprising a processor;
a communication device in communication with the embedded device and operable to communicate via a communication network; and
a non-transitory computer readable medium storing a server interface comprising processor-executable code that when executed causes the processor to:
establish, with the communication device, a connection with a remote network element in a transport network; and
responsive to receiving a SUBSCRIBE request from the remote network element via the connection:
initialize a data collector operable to continually copy, at a predetermined data collection rate, a value stored at a location in a database, the location based at least in part on a target of the SUBSCRIBE request;
store the value as a particular one of a plurality of responses; and
transmit, at a predetermined data transmission rate, each of the plurality of responses to the remote network element via the connection.

13. The network element of claim 12, wherein the SUBSCRIBE request is a remote procedure call, and each of the plurality of responses is a remote procedure response.

14. The network element of claim 13, wherein the SUBSCRIBE request is a gRPC call, and each of the plurality of responses is a gRPC response.

15. The network element of claim 14, wherein each of the SUBSCRIBE request and the plurality of responses is formatted in a protocol buffer format.

16. The network element of claim 12, wherein the predetermined data collection rate is based at least in part on a data collection rate of the SUBSCRIBE request and the predetermined data transmission rate is based at least in part on a data transmission rate of the SUBSCRIBE request.

17. The network element of claim 12, wherein the SUBSCRIBE request having a target is a first SUBSCRIBE request having a first target, the predetermined data collection rate is a first predetermined data collection rate, the data collector is a first data collector, the value is a first value, the predetermined data transmission rate is a first data transmission rate, the plurality of responses is a first plurality of responses, and the server interface further comprises processor-executable code that when executed causes the processor to:
responsive to receiving a second SUBSCRIBE request from the remote network element via the connection:
initialize a second data collector operable to continually copy, at a second predetermined data collection rate, a second value stored at a second location in the database, the second location based at least in part on a second target of the second SUBSCRIBE request;
store the second value as a particular one of a second plurality of responses; and
transmit, at a second predetermined data transmission rate, each of the second plurality of responses to the remote network element via the connection.

18. The network element of claim 17, wherein the transport network is an optical transport network.

19. The network element of claim 18, wherein the embedded device further comprises a digital coherent optics module having one or more coherent optical transceiver operable to transmit and/or receive client data in the optical transport network.

20. The network element of claim 17, wherein the processor is one or more of a digital signal processor, an application specific integrated circuit, a field programmable gate array, a microprocessor, and a central processing unit.

21. The network element of claim 17, wherein the embedded device is one or more of a Wavelength Selective Switch (WSS), a Variable Optical Attenuator (VOA), an Erbium Doped Fiber Amplifier (EDFA), an optical laser, a Raman amplifier, and an optical channel monitor.
